(19) United States
(12) Patent Application Publication
(10) Pub. No.: US 2005/0159106 A1
(43) Pub. Date: Jul. 21, 2005

(54) Method and system for assigning time-frequency codes

(76) Inventors: Arto Palin, Viiala (FI); Juha Salokannel, Kangasala (FI); Jukka Reunamaki, Tampere (FI)

Correspondence Address: MORGAN & FINNEGAN, L.L.P., 3 WORLD FINANCIAL CENTER, NEW YORK, NY, 10281-2101, US

(21) Appl. No.: 10/747,096

(22) Filed: Dec. 30, 2003

(51) Int. Cl. H04B 7/00; H04B 1/69; H04B 1/707; H04B 1/713

(52) U.S. Cl. 455/41.2; 375/132

(57) ABSTRACT

A condition of a short-range wireless communications link is determined. From this determination, one or more frequency hopping patterns are selected for the short-range wireless communications link. The selected pattern(s) may employ different frequencies for adjacent time slots when the determined condition indicates the short-range wireless communications link is susceptible to inter-symbol interference (ISI). Conversely, the selected patterns may employ the same frequencies for two or more adjacent time slots when the determined condition indicates the short-range wireless communications link is not susceptible to ISI.

### FIELD OF THE INVENTION

The present invention relates to wireless communications. More particularly, the present invention relates to techniques for allocating communications resources based on wireless link conditions.

### BACKGROUND OF THE INVENTION

Short-range wireless proximity networks typically involve devices that have a communications range of one hundred meters or less. To provide communications over long distances, these proximity networks often interface with other networks. For example, short-range networks may interface with cellular networks, wireline telecommunications networks, and the Internet.

IEEE 802.15.3 defines an ad hoc wireless short-range network (referred to as a piconet) in which a plurality of devices may communicate with each other. One of these devices is called piconet coordinator (PNC), which coordinates timing and other operational characteristics. The remaining devices in the network are known as DEVs. The timing of piconets is based on a repeating pattern of “superframes” in which the network devices may be allocated communications resources.

A high rate physical layer (PHY) standard is currently being selected for IEEE 802.15.3a. The existing IEEE 802.15.3 media access control layer (MAC) is supposed to be used as much as possible with the selected PHY. Currently, there are two remaining PHY candidates. One of these candidates is based on frequency hopping application of orthogonal frequency division multiplexing (OFDM). The other candidate is based on M-ary Binary offset Keying. The OFDM proposal is called Multiband OFDM (MBO). MBO is viewed as the stronger candidate.

MBO utilizes OFDM modulation and frequency hopping. MBO frequency hopping involves the transmission of each of the OFDM symbols at one of three frequencies according to pre-defined code. Since MBO provides only three hopping channels, only a limited number of different hopping sequences are available.

Some of these frequency hopping sequences are more susceptible to generating an occurrence known as inter-symbol interference (ISI). ISI occurs when a previous symbol overlaps with a current symbol at a receiver. ISI may result in symbol errors, consequently reducing network capacity. Accordingly, techniques are needed to reduce undesirable conditions, such as ISI.

### SUMMARY OF THE INVENTION

The present invention is directed to a method and system that determines a condition of a short-range wireless communications link, and selects frequency hopping pattern(s) for the short-range wireless communications link based on a susceptibility of inter-symbol interference (ISI) indicated by the determined condition. These selected pattern(s) may employ different frequencies for adjacent time slots when the determined condition indicates that the short-range wireless communications link is susceptible to ISI. Conversely, the selected patterns may employ the same frequencies for two or more adjacent time slots when the determined condition indicates the short-range wireless communications link is not susceptible to ISI.

Determining a condition of the link may include determining an impulse response of the link. This may be determined from a channel estimation sequence received across the link or using preamble sequence correlation. From this impulse response, a delay spread is indicated.

Accordingly, the system and method may select frequency hopping pattern(s) employing different frequencies for adjacent time slots when the impulse response of the link indicates a delay spread that is greater than a predetermined duration. Conversely, the system and method may select frequency hopping pattern(s) employing the same frequencies for two or more adjacent time slots when the impulse response of the link indicates a delay spread that is less than a predetermined duration.

In addition, the method and system may transmit a request to a remote device to employ at least one of the selected pattern(s). This remote device may be a device that is responsible for coordinating communications across the link, such as a piconet coordinator. In response to this request, the method and system may receive a command from the remote device to employ a particular frequency hopping pattern.

The present invention advantageously improves network capacity. Further features and advantages of the present invention will become apparent from the following description and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an available spectrum for a short-range communications system in which the principles of the present invention may be applied;

FIG. 2 is a diagram showing spread spectrum signal transmission according to a particular time frequency code;

FIG. 3 is a table showing various time frequency codes;

FIG. 4 is a diagram showing a sequence of transmitted signals in which inter-symbol interference occurs;

FIG. 5 is a diagram of an exemplary operational scenario in which the principles of the present invention may be applied;

FIG. 6 is a diagram showing an exemplary operation of a rotation sequence;

FIG. 7 is a diagram of a transmitting device and a receiving device according to one embodiment of the present invention;

FIG. 8 is a diagram of an energy estimation module implementation according to one embodiment of the present invention; and

FIG. 9 is a flowchart of an operational sequence according to one embodiment of the present invention;

### DETAILED DESCRIPTION OF THE PREFERRED EMBODIMENTS

I. Frequency Hopping

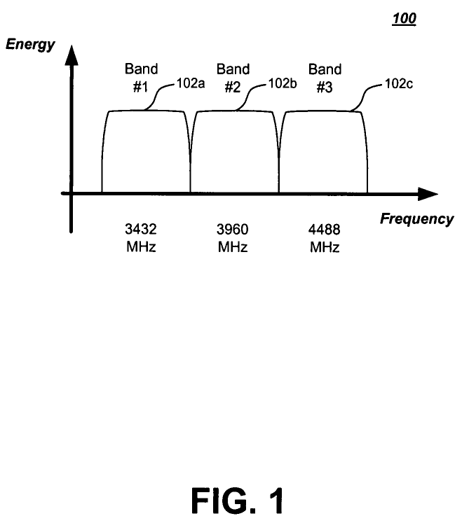

FIG. 1 is a diagram of an available spectrum 100 for a short-range communications system in which the principles of the present invention may be applied, such as an IEEE 802.15.3a network. As shown in FIG. 1, this spectrum includes three frequency channels 102. In particular, spectrum 100 includes a first channel 102a centered at 3432 MHz, a second channel 102b centered at 3960 MHz, and a third channel 102c centered at 4488 MHz.

According to MBO, channels 102 may be used as hopping channels. When used in this manner, each symbol (e.g., each OFDM symbol) is transmitted in one of channels 102 according to a pre-defined code. In IEEE 802.15.3a, such a code is referred to as a time frequency code (TFC). This technique provides for frequency diversity, as well as robustness against multi-path propagation and interference. In addition, this technique allows for multiple-access by utilizing different TFCs for adjacent piconets.

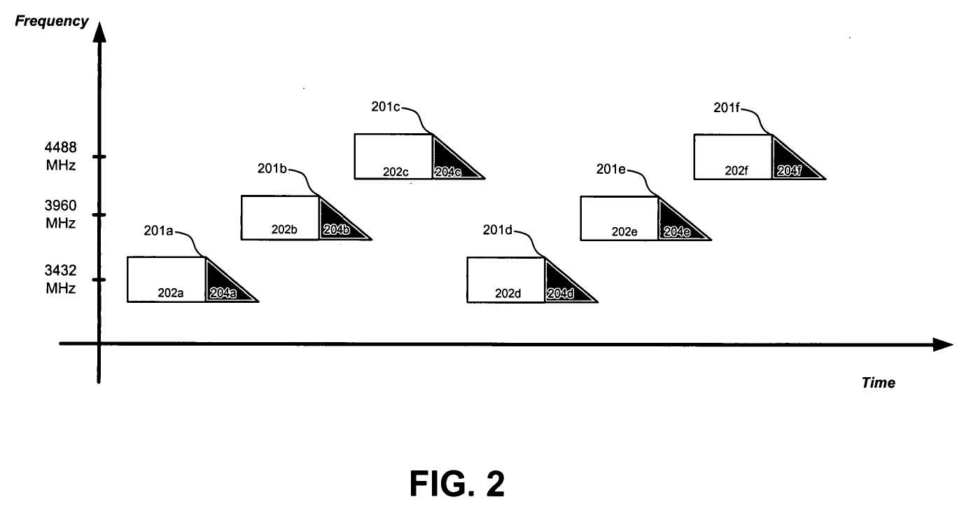

An example of this frequency-hopping technique is shown in FIG. 2. FIG. 2 is a diagram showing signal transmission that employs a particular TFC. In this TFC, symbols are transmitted at frequencies according to a repeating sequence. As shown in FIG. 2, this sequence is first channel 102a, followed by second channel 102b, followed by third channel 102c.

FIG. 2 also shows a sequence of transmitted signals 201. These signals are shown from the perspective of a receiving device. Accordingly, each of signals 201 includes a symbol portion 202 and a spreading portion 204 (also referred to herein as delay spread). The time intervals between the beginning of consecutively transmitted symbol portions (such a symbol portions 201 and 201b) are referred to herein as time slots. Spreading portions 204 are the result of multipath propagation. The duration of spreading portions 204 may be determined by various factors, such as the distance between the transmitting and receiving devices and whether the path between these devices is within a line of sight.

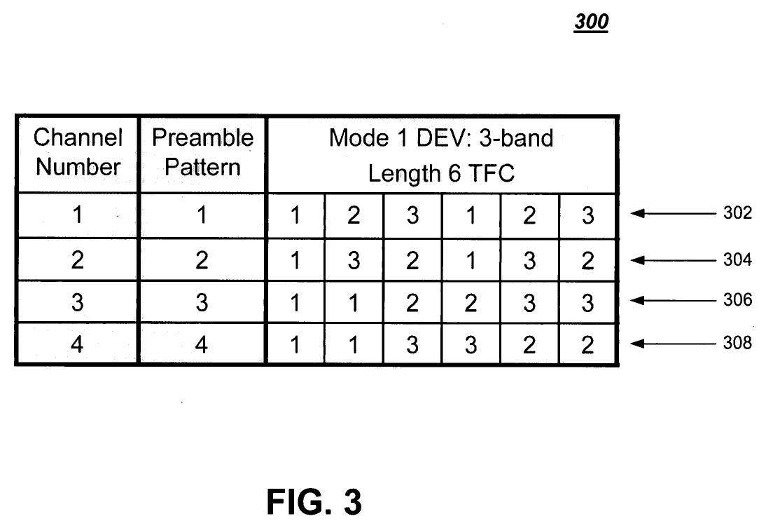

According to the MBO proposal, different TFC codes may be used to support multiple piconets in the same area. Since spectrum 100 provides only three channels, a limited number of different hopping sequences (i.e., TFCs) are available. FIG. 3 is a table showing various TFC codes used for the spectrum of FIG. 1. In this table, “1” refers to channel 102a, “2” refers to channel 102b, and “3” refers to channel 102c. In FIG. 3, a TFC 302 employs the channel sequence 1, 2, 3, 1, 2, 3, while a TFC 304 employs the channel sequence 1, 3, 2, 1, 3, 2. Thus, TFCs 302 and 304 do not use the same physical channel for adjacently transmitted signals. In contrast, FIG. 3 includes TFCs 306 and 308, which use the same physical channels for adjacently transmitted signals. For instance, TFC 306 employs the channel sequence 1, 1, 2, 2, 3, 3, while TFC 308 employs the channel sequence 1, 1, 3, 3, 2, 2.

For TFCs 302 and 304, delay spread caused by multi-path propagation does not promote inter-symbol interference (ISI). This is because the same physical channel isn't used for adjacently transmitted symbols. Accordingly, TFCs 302 and 304 provide sufficient time for any delay spread to vanish.

However, for TFCs 306 and 308, delay-spread caused by multi-path propagation may result in inter-symbol interference (ISI). This is because the use of the same physical channel for adjacently transmitted symbols may not provide sufficient time for delay spread to vanish. In the best case, ISI does not result for such TFCs. However, in certain propagation environments, ISI may occur.

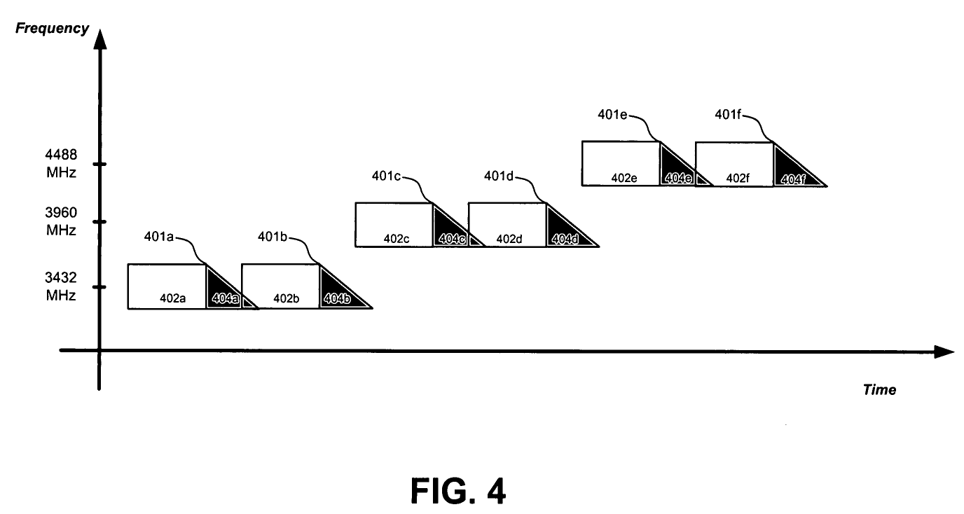

FIG. 4 is a diagram showing a sequence of transmitted signals 401, in which ISI occurs. These signals are transmitted according to TFC 306. Therefore, FIG. 4 shows the transmission of signals 401 in the following sequential order: signals 401a and 401b in channel 102a, signals 401b and 401c in channel 102b, and signals 401e and 401f in channel 102c.

These signals are shown from the perspective of a receiving device. Accordingly, each of signals 401 includes a symbol portion 402 and a spreading portion 404. Spreading portions 404 are the result of multipath propagation. As shown in FIG. 4, the use of TFC 306 results in certain spreading portions 404 overlapping in both frequency and time with certain symbol portions 402. For instance, FIG. 4 shows that spreading portion 404a overlaps with symbol portion 402b, spreading portion 404c overlaps with symbol portion 402d, and spreading portion 404e overlaps with symbol portion 402f. This overlapping, also known as ISI, may result in the erroneous demodulation of symbols.

FIG. 4 shows a situation having a delay spread that is sufficient to cause a significant amount of overlap. However, other situations may have a smaller amount of delay spread so that the amount of overlap is less (or even non-existent).

II. Operational Environment

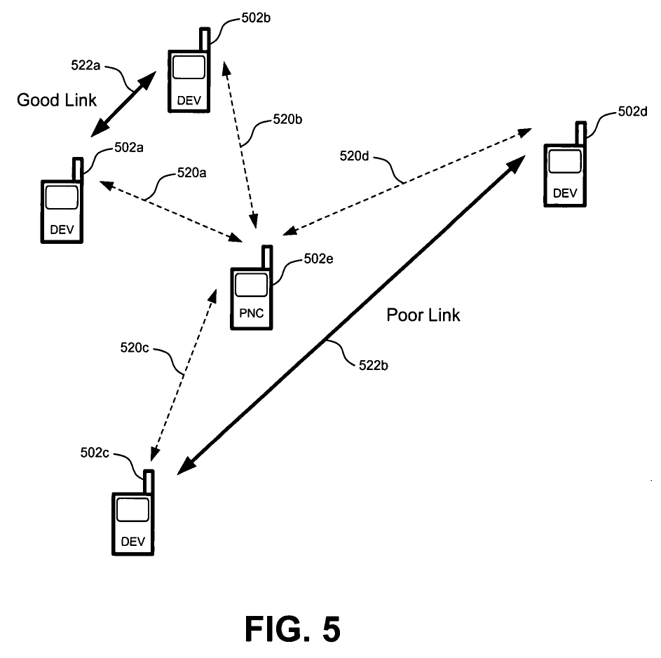

FIG. 5 is a diagram of an exemplary operational environment in which the principles of the present invention may be applied. This environment includes a piconet having a plurality of devices. These devices include a piconet coordinator (PNC) 502e, and member devices (DEVs) 502a-d.

Each of devices 502a-d communicate with PNC 502e across a corresponding link 520. For example, DEV 502a communicates with PNC 502e across a link 520a. In addition, DEVs 520a-d may communicate with each other directly across direct links 522. For instance, FIG. 5 shows DEVs 502a and 502b communicating via a direct link 522a, as well as DEVs 502c and 502d communicating across a direct link 522b.

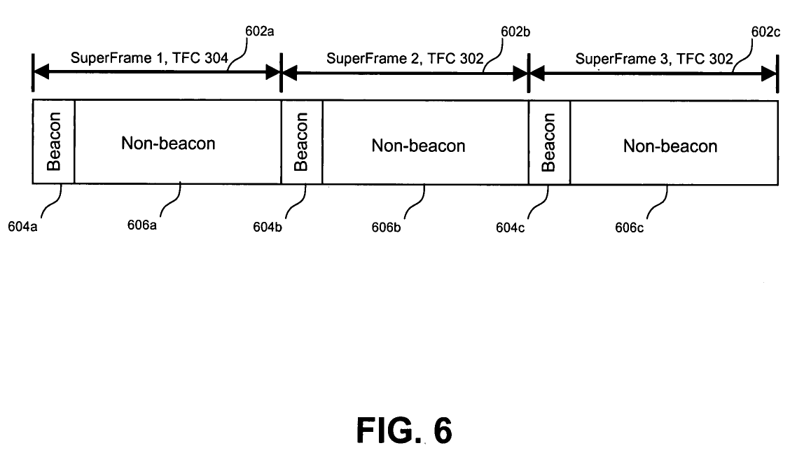

Each of links 522 and 520 may employ different frequency hopping patterns. Each of these patterns may include, for example, one or more TFCs and/or rotation sequences. Rotation sequences are repeating patterns proposed by MBO to coordinate the use of TFCs. More particularly, a rotation sequence (RS) defines the order in which various TFCs are used for a particular link. For instance, an RS assigns TFCs to superframes. FIG. 6 is a diagram showing an exemplary operation of a rotation sequence in the context of the IEEE 802.15.3 superframe format.

In particular, FIG. 6 shows a frame format having superframes 602a, 602b, and 602c. As shown in FIG. 6, superframe 602b immediately follows superframe 602a, and superframe 602c immediately follows superframe 602b. Each superframe 602 includes a beacon portion 604 and a non-beacon portion 606. Beacon portions 604 are transmitted by a PNC (such as PNC 502e) and are used to set timing allocations and to communicate management information for the piconet. For example, beacon portions 604 may direct devices in the piconet (e.g., DEVs 502a-d) to employ certain frequency hopping patterns, such as specific TFCs and rotation sequences.

Non-beacon portions 606 are used for devices to communicate data according to, for example, the frequency hopping techniques described herein. For instance, non-beacon portions 606 may support data communications across links 520 and 522. In addition, devices (e.g., DEVs 502a-d) may use non-beacon portions 606 to transmit control information, such as request messages to other devices (e.g., PNC 502e).

FIG. 6 shows the allocation of particular TFCs to particular superframes for a particular link (e.g., a particular link 522). As described above, a rotation sequence defines a pattern in which TFCs are used for a series of consecutive superframes. For instance, FIG. 6 shows a pattern involving three different TFCs. According to this pattern, each of superframes 602a-c employs one of the TFCs shown in FIG. 3. In particular, TFC 304 is used in superframe 602a, TFC 302 is used in superframe 602b, and TFC 302 is used in superframe 602c.

The rotation sequence of FIG. 6 may be employed for a particular link. For example, with reference to FIG. 5, this rotation sequence may be employed for a particular one of links 522 and 520. The employment of rotation sequences reduces the collision of transmissions between different rotation sequences. However, when forcing each device to use every available TFC, network capacity may be reduced due to ISI.

Referring again to FIG. 5, link 522a is shown as a good link, while link 522b is shown as a poor link. This means that less spreading (i.e., a smaller delay spread) occurs in communications across link 522a than in communications across link 522b. Accordingly, link 522b is more susceptible to ISI than link 522a. The present invention provides techniques for the selection of frequency hopping patterns such that in poor communications links, adjacent symbols are not transmitted across the same physical channel (i.e., the same frequencies). This advantageously increases channel capacity by reducing the number of symbol errors due to ISI.

For instance, since link 522b is identified as poor, it may use one or more TFCs that do not employ the same frequencies for adjacently transmitted symbols (e.g., OFDM symbols). Referring to FIG. 3, examples of such TFCs include TFCs 302 and 304. Moreover, link 522b may employ such TFCs in a repeating pattern. A rotation sequence which uses particular TFCs for particular superframes, is an example of such a pattern.

Conversely, since link 522a is identified as good, it may use one or more TFCs that employ the same frequencies for adjacently transmitted symbols (e.g., OFDM symbols). Examples of such TFCs include TFCs 306 and 308. Such TFCs may be employed by link 522a in a repeating pattern, such as a superframe-based rotation sequence.

III. Device Implementation

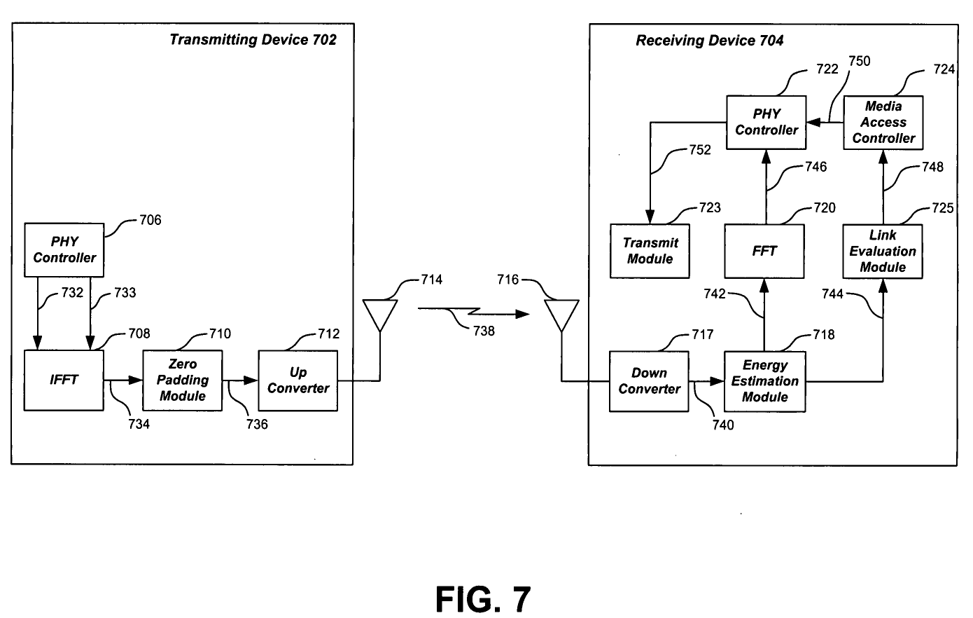

FIG. 7 is a diagram of a transmitting device 702 and a receiving device 704 according to one embodiment of the present invention. These devices may be employed in various communications environments, such as the environment of FIG. 5. Accordingly, devices 702 and 704 may communicate across a link, such as one of links 522 and 520.

As shown in FIG. 7, transmitting device 702 includes a physical layer (PHY) controller 706, an inverse fast fourier transform (IFFT) module 708, a zero padding module 710, an upconverter 712, and an antenna 714. Receiving device 704 includes an antenna 716, a downconverter 717, an energy estimation module 718, a fast fourier transform (FFT) module 720, a PHY controller 722, a transmit module 723, a media access controller 724, and a link evaluation module 725.

PHY controller 706 generates a “frequency-domain sequence” 732. This sequence corresponds to a channel estimation sequence that will be used by receiving device 704 to determine channel properties associated with the communications link. PHY controller 706 may also generate additional sequences. For instance, FIG. 7 shows an additional sequence 733. Additional sequence 733 may convey information, such as payload data associated with applications, as well as header information. Such header information may be associated with the physical layer, as well as other protocol layers (e.g., the MAC layer).

As shown in FIG. 7, IFFT module 708 generates an OFDM modulated signal 734 from sequences 732 and 733. Signal 734 includes one or more OFDM symbols. These symbol(s) are generated from sequences 732 and 733 by performing one or more inverse fast fourier transforms for each signal.

Signal 734 is sent to zero padding module 710, which appends one or more “zero samples” to the beginning of each OFDM symbol in signal 734. This produces a padded modulated signal 736. Signal 736 has a portion derived from sequence 732. As described below, this portion will be used by receiving device 704 as a channel estimation sequence for determining characteristics of the link (i.e., channel) between devices 702 and 704.

Upconverter 712 receives padded signal 736 and employs carrier-based techniques to place padded signal 736 into one or more frequency channels. These one or more frequency channels are determined according to a hopping pattern, such as the TFCs described above. As a result, upconverter 712 produces a signal 738, which is transmitted to receiving device 704 through antenna 714.

FIG. 7 shows that antenna 716 of device 704 receives signal 738 and passes it to downconverter 717. Downconverter 717 employs carrier-based techniques to convert signal 738 from its one or more frequency channels into a predetermined lower frequency range. This results in a modulated signal 740, which is sent to energy estimation module 718.

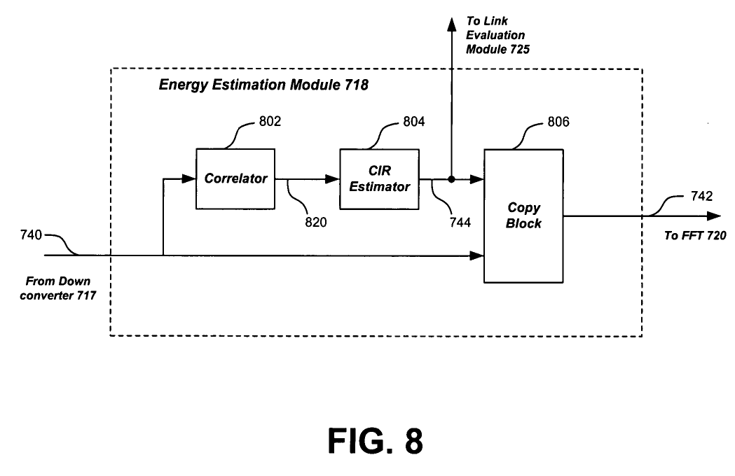

Modulated signal 740 corresponds to signal 736. Accordingly, a portion of signal 740 is derived from sequence 732. Energy estimation module 718 uses this portion, or a separate preamble, as a channel estimation sequence to determine properties of the communications link (channel) between transmitting device 702 and receiving device 704. In particular, energy estimation module 718 estimates the channel's impulse response. This estimation produces an impulse response estimate 744, which is sent to link evaluation module 725. An implementation of energy estimation module 718 is described below in greater detail with reference to FIG. 8.

Impulse response estimate 744 identifies the amount of delay spread that will occur in the channel. The amount of delay spread indicates the extent to which ISI may occur. Accordingly, link evaluation module 725 determines whether the link between transmitting device 702 and receiving device 704 is susceptible to ISI (i.e., whether this link is a “poor link”).

Link evaluation module 725 may determine the condition of the link between devices 702 and 704 according to various techniques. For instance, link evaluation module 725 may characterize the link as a poor link when impulse response estimate 744 indicates a delay spread that is greater than a predetermined duration. This may occur when impulse response estimate 744 has a magnitude greater than a predetermined threshold at a predetermined delay time. Conversely, link evaluation module 725 may characterize the link as a good link when impulse response estimate 744 indicates a delay spread that is less than a predetermined duration. This may occur when impulse response estimate 744 has a magnitude less than a predetermined threshold at a predetermined delay time.

If link evaluation module 725 determines that the link is a poor one, it sends an ISI susceptibility message 748 to media access controller 724. Upon receipt of message 748, media access controller 724 determines whether the link between devices 702 and 704 is using a frequency hopping pattern, such as one or more TFCs, that may cause ISI. If so, then media access controller 724 initiates a request 750 for a frequency hopping pattern that will not cause ISI. Such a frequency hopping pattern may include one or more TFCs that do not employ the same frequencies for two or more adjacent time slots.

As shown in FIG. 7, request 750 is sent to PHY controller 722. In turn, PHY controller 722 formats this request (e.g., adds appropriate header fields, etc.) and generates message 752, which is sent to transmit module 723 for transmission to the remote device that controls network resources, such as a PNC (not shown). Accordingly, transmit module 723 includes components, such as a modulator, an amplifier, an upconverter, and an antenna, to provide for transmission of message 752 to the remote device.

The remote device may approve this request and assign a suitable frequency hopping pattern to the link between devices 702 and 704. Once assigned, the remote device transmits a message to devices 702 and 704. This message informs these devices of the assigned frequency hopping pattern. Device 704 may receive this message through antenna 716 and process it with energy estimation module 718, FFT module 720, and PHY controller 722. Device 702 may also receive and process this message through similar components (not shown). Once this message is received, upconverter 712 and downconverter 717 may operate according to the assigned frequency hopping pattern.

In addition to generating requests for frequency hopping patterns that are not capable of causing ISI, receiving device 704 may make requests the contrary. For instance, if link evaluation module 725 determines that the link between devices 702 and 704 is a good link (i.e., not susceptible to ISI), it may generate a message (not shown) which is sent to media access controller 724. This message indicates the existence of a good link.

If the good link between devices 702 and 704 is employing a frequency hopping pattern that is not likely to cause ISI (even in a poor link), then media access controller 724 may generate a request (not shown). This request is for a frequency hopping pattern that will not cause ISI in the good link, even though it would possibly cause ISI in a poor link. For instance, such a pattern is one that employs the same frequencies for adjacently transmitted signals. This request may be processed and transmitted in same manner as request 750. Also, a frequency hopping pattern may be assigned by a remote device and communicated to devices 702 and 704 in the manner described above.

In addition to generating impulse response estimate 744, FIG. 7 shows that energy estimator 718 generates a signal 742, which is sent to FFT module 720 for OFDM demodulation. This demodulation involves performing a fast fourier transform for each symbol in signal 742. As a result of this demodulation, a sequence 746 is sent to PHY controller 722. Sequence 746 may convey information, for example, payload data. Upon receipt, PHY controller 722 processes information sequence 746. This may involve sending portions of its conveyed information (e.g., payload data) to higher level processes, such as one or more applications (not shown).

Although FIG. 7 shows device 702 transmitting signals and device 704 receiving these signals, modifications to this implementation are within the scope of the present invention. For example, in embodiments of the present invention, each of these devices may handle both the transmission and reception of signals according to the techniques described herein.

FIG. 8 is a diagram showing an implementation of energy estimation module 718 according to one embodiment of the present invention. This implementation includes a correlator 802, a channel impulse response (CIR) estimator 804, and a copy block 806. As described above with reference to FIG. 7, energy estimation module 718 uses the portion of signal 740 that is derived from sequence 732 as a channel estimation sequence to determine properties of the communications link (channel). According to an alternative embodiment, a separate time domain preamble could be used to determine the properties of the communications link instead of using the portion derived from the sequence 732.

Accordingly, FIG. 8 shows correlator 802 receiving signal 740 to perform a correlation operation on the portion of signal 740 associated with sequence 732. In particular, correlator 802 correlates this portion of signal 740 with a stored sequence that matches sequence 732. The result of this correlation produces an output signal 820 conveying the link's response characteristics, which is sent to CIR estimator 804.

CIR estimator 804 generates an estimate of the channel's impulse response. This estimate is in the form of impulse response estimate 744. As described above, impulse response estimate 744 is sent to link evaluation module 725. In addition, FIG. 8 shows that impulse response estimate 744 is also sent to copy block 806.

For each OFDM symbol conveyed in signal 740, copy block 806 copies the echoes occurring at the end of the symbol into the zero padded portion at the beginning of the symbol. These echoes are determined from signal 740 based on impulse response estimate 744. This copy procedure produces signal 742. MBO proposes this copy procedure. Accordingly, embodiments of the present invention advantageously employ information (e.g., impulse response estimate 744) that is needed to implement the MBO proposal, regardless of whether the techniques described herein are employed.

Further modifications are also within the scope of the present invention. For instance, as described above, impulse response estimation is based on a “frequency-domain sequence” 732, which is sent to IFFT module 708 to generate a corresponding “time-domain” channel estimation sequence that will be used by receiving device 704 to determine the impulse response of the link between devices 702 and 704. However, a time-domain sequence (not shown) that is inserted as a preamble into signal 734 after IFFT module 708 may alternatively be used. This preamble may be added to signal 734 before it is sent to zero padding module 710.

Moreover, the impulse response estimate may be obtained in the time-domain or the frequency-domain. In FIG. 7, the time domain signal (e.g., preamble) corresponding to sequence 732 is known. Thus, the implementation in FIG. 7 employs a time domain approach to channel estimation. In the frequency domain, estimation techniques may be performed after demodulation is performed (for example, by FFT module 720). These estimation techniques may involve the correlation-based operation described above. At this point, energy link evaluation module 725 may use the estimated impulse response to determine whether the link between devices 702 and 704 is susceptible to ISI.

The devices of FIG. 7 may be implemented in hardware, software, firmware, or any combination thereof. For instance, upconverter 712, downconverter 717, and transmit module 723 may include electronics, such as amplifiers, mixers, and filters. Moreover, implementations of these devices may include digital signal processor(s) (DSPs) to implement various modules, such as IFFT module 708, zero padding module 710, energy estimation module 718, FFT module 720, and link evaluation module 725. Moreover, in embodiments of the present invention, processor(s), such as microprocessors, executing instructions (i.e., software) that are stored in memory (not shown) may be used to control the operation the components of these devices. In addition, components, such as PHY controllers 706 and 722, and media access controller 724 may be primarily implemented through software operating on one or more processors.

IV. Operation

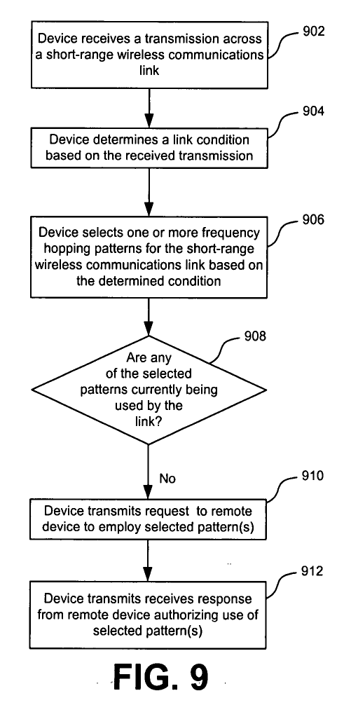

FIG. 9 is a flowchart of an operational sequence according to one embodiment of the present invention. This operation may be employed by a wireless communications device, such as device 704.

As shown in FIG. 9, this sequence begins with a step 902. In this step, the device receives a signal transmittted across a short-range wireless communications link. With reference to the implementations of FIG. 7, this signal may include a channel estimation or preamble sequence.

In a step 904, the device determines a link condition based on the received transmission. For instance, step 904 may comprise determining whether the link is susceptible to ISI. This susceptibility may be based on the extent of delay spread in the link. For instance, a delay spread greater than a predetermined threshold indicates susceptibility to ISI. Step 904 may include, for example, calculating an impulse response of the short-range wireless link from a channel estimation or preamble sequence received in step 902.

In a step 906, the device selects one or more frequency hopping patterns for the link based on the link condition determined in step 904. These one or more patterns may be a specific frequency hopping pattern (e.g., a particular TFC or RS). Alternatively, these one or more patterns may be a group of patterns. For instance, when the link is susceptible to ISI, the one or more frequency hopping patterns may be all patterns that employ different frequencies for adjacent time slots. However, when the when the link is not susceptible to inter-symbol interference (ISI), the one or more frequency hopping patterns may be all patterns that employ the same frequencies for two or more adjacent time slots.

In a step 908, the device determines whether the short-range wireless communications link is currently using only frequency hopping patterns from the one or more patterns selected in step 906. If not, then a step 910 is performed. If the pattern(s) are already used, the next possible pattern that will cause least amount of ISI may be selected when the link is susceptible to ISI. In this step, the device transmits a request to employ such frequency hopping patterns. This request may be transmitted to a remote device that is responsible for coordinating communications across the link, such as a PNC.

A step 912 follows step 910. In this step, the device receives a message from the remote device directing the device to employ a particular frequency hopping pattern (e.g., a TFC or RS) from the one or more patterns selected in step 906.

V. Conclusion

While various embodiments of the present invention have been described above, it should be understood that they have been presented by way of example only, and not in limitation. For instance, although examples have been described involving IEEE 802.15.3 and/or IEEE 802.15.3a communications, other short-range and longer range communications technologies are within the scope of the present invention. Also, the present invention is not limited to implementations involving only three frequency channels. Moreover, the techniques of the present invention may be used with signal transmission techniques other than OFDM, TFCs, and/or RSs.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method, comprising:
(a) determining a condition of a short-range wireless communications link; and
(b) selecting one or more frequency hopping patterns for the short-range wireless communications link based on a susceptibility to inter-symbol interference (ISI) indicated by the determined condition.

2. The method of claim 1, wherein step (b) comprises selecting as the one or more frequency hopping patterns, one or more patterns employing different frequencies for adjacent time slots when the determined condition indicates the short-range wireless communications link is susceptible to ISI.

3. The method of claim 1, wherein step (b) comprises selecting as the one or more frequency hopping patterns, one or more patterns employing the same frequencies for two or more adjacent time slots when the determined condition indicates the short-range wireless communications link is not susceptible to ISI.

4. The method of claim 1, wherein step (a) comprises determining an impulse response of the short-range wireless communications link.

5. The method of claim 4, wherein step (b) comprises selecting as the one or more frequency hopping patterns, one or more patterns employing different frequencies for adjacent time slots when the impulse response of the short-range wireless communications link indicates a delay spread that is greater than a predetermined duration.

6. The method of claim 4, wherein step (b) comprises selecting as the one or more frequency hopping patterns, one or more patterns employing the same frequencies for two or more adjacent time slots when the impulse response of the short-range wireless communications link indicates a delay spread that is less than a predetermined duration.

7. The method of claim 4, wherein step (b) comprises selecting as the one or more frequency hopping patterns, one or more patterns employing different frequencies for adjacent time slots when the impulse response of the short-range wireless communications link has a magnitude greater than a predetermined threshold at a predetermined delay time.

8. The method of claim 4, further comprising:
receiving across the short-range wireless communications link a channel estimation sequence from a remote wireless communications device; and
wherein the impulse response is determined from the received channel estimation sequence.

9. The method of claim 1, further comprising:
transmitting a request to employ at least one of the one or more selected frequency hopping patterns to a remote device that is responsible for coordinating communications across the short-range wireless communications link.

10. The method of claim 9, further comprising:
receiving a command from the remote device to employ at least one of the one or more selected frequency hopping patterns.

11. The method of claim 1, wherein the one or more selected frequency hopping patterns are based on at least one of a plurality of time frequency codes (TFCs).

12. The method of claim 11, wherein the one or more selected frequency hopping patterns are based on two or more of the plurality of TFCs arranged according to a rotation sequence (RS).

13. The method of claim 1, wherein the short-range wireless communications link is an IEEE 802.15.3 link.

14. The method of claim 1, wherein the short-range wireless communications link conveys orthogonal frequency division multiplexing (OFDM) signals.

15. A system, comprising:
a first wireless communications device; and
a second wireless communications device that receives transmissions from the first wireless communications device communications device across a short range wireless communications link;
wherein the short-range wireless communications link employs a frequency hopping pattern based on a susceptibility of the link to inter-symbol interference (ISI).

16. The system of claim 15, wherein the frequency hopping pattern employs different frequencies for adjacent time slots when the short-range wireless communications link is susceptible to inter-symbol interference (ISI).

17. The system of claim 15, wherein the frequency hopping pattern employs the same frequencies for two or more adjacent time slots when the short-range wireless communications link is not susceptible to inter-symbol interference (ISI).

18. The system of claim 15, wherein the short-range wireless communications link is an IEEE 802.15.3 link.

19. The system of claim 15, wherein the short-range wireless communications link conveys orthogonal frequency division multiplexing (OFDM) signals.

20. A wireless communications device, comprising:
means for determining a condition of a short-range wireless communications link; and
means for selecting one or more frequency hopping patterns for the short-range wireless communications link based on a susceptibility to inter-symbol interference (ISI) indicated by the determined condition.

21. The system of claim 20, wherein said means for selecting comprises means for selecting as the one or more frequency hopping patterns, one or more patterns employing different frequencies for adjacent time slots when the determined condition indicates the short-range wireless communications link is susceptible to ISI.

22. The system of claim 20, wherein said means for selecting comprises means for selecting as the one or more frequency hopping patterns, one or more patterns employing the same frequencies for two or more adjacent time slots when the determined condition indicates the short-range wireless communications link is not susceptible to ISI.
